(19) United States
(12) Patent Application Publication
(10) Pub. No.: US 2023/0053335 A1
(43) Pub. Date: Feb. 23, 2023

(54) ELECTROLYTE AND ELECTRODE PASTE FOR LITHIUM-ION BATTERY, LITHIUM-ION BATTERY, AND METHOD OF MANUFACTURING LITHIUM-ION BATTERY WITH ENHANCED PERFORMANCE

(71) Applicant: EVOQ NANO, INC., Salt Lake City, UT (US)

(72) Inventor: William H. Niedermeyer, West Jordan, UT (US)

(21) Appl. No.: 17/890,263

(22) Filed: Aug. 17, 2022

Related U.S. Application Data
(60) Provisional application No. 63/234,676, filed on Aug. 18, 2021.

(51) Int. Cl. H01M 10/0567; H01M 10/0525; H01M 10/0568; H01M 10/0565; H01M 10/0569; H01M 4/62; H01M 4/525; H01M 4/587; H01M 4/36; H01M 10/058; H01M 10/42

(52) U.S. Cl. CPC H01M 10/0567; H01M 10/0525; H01M 10/0568; H01M 10/0565; H01M 10/0569; H01M 4/62; H01M 4/525; H01M 4/587; H01M 4/366; H01M 10/058; H01M 10/4235; H01M 2300/0037; H01M 2004/028

(57) ABSTRACT

This disclosure relates to improved electrolytes and electrode pastes that include ground state metal nanoparticles formed by laser ablation, improved rechargeable lithium-ion batteries made using the improved electrolytes and/or electrode pastes that include ground state metal nanoparticles formed by laser ablation, and methods for manufacturing rechargeable batteries of improved performance. The metal nanoparticles may comprise or consist of gold. The metal nanoparticles may by spherical-shaped and/or coral-shaped.

### CROSS-REFERENCE TO RELATED APPLICATIONS

This application claims the benefit of U.S. Provisional Application No. 63/234,676, filed Aug. 18, 2021, which is incorporated by reference in its entirety.

### BACKGROUND

Rechargeable batteries are used for many different purposes, including vehicles, buildings, stationary storage, and portable electronic devices. Lead-acid batteries are the most common type of rechargeable battery for use in internal combustion vehicles, including cars, trucks, boats, and the like. Although lead-acid batteries have low energy density compared to newer battery technologies, their ability to reliably provide relatively large surge currents makes them effective for starting and providing auxiliary power for internal combustion motors. Lead-acid batteries are also relatively inexpensive compared to newer battery technologies, making them attractive choices for providing rechargeable power even in circumstances outside the motor vehicle field, such as stationary reserve power where weight is not a major issue.

Another common type of batteries are lithium-ion batteries. The three primary functional components of a lithium-ion battery are the positive electrode, negative electrode, and electrolyte. These are encased within a container, which can be metal or plastic, but which is typically plastic to reduce weight. The “negative electrode” of a conventional lithium-ion cell typically includes lithium metal intercalated with layers of graphite, and the positive electrode typically includes a lithium-metal oxide intercalated with the layers of metal oxide. The electrolyte is typically a lithium salt in an organic solvent. The electrochemical roles of the electrodes reverse between anode and cathode, depending on the direction of current flow through the cell. During discharge, the “anode” includes lithium metal, which is oxidized in the oxidation half reaction to produce lithium ions and electrons that go into the circuit. The “cathode” collects the lithium ions that have passed through the electrolyte and combines them with metal oxide in the reduction half reaction at the “cathode” to produce lithium-metal oxide, with the metal species of the metal oxide being reduced by electrons received at the cathode to maintain charge balance.

The designations of “anode” and “cathode” are reversed when recharging the battery. During recharging, the metal species of the lithium-metal oxide is oxidized to the metal oxide at the “anode”, releasing lithium ions that migrate through the electrolyte to the “cathode”, where they are reduced to lithium metal.

The most common commercially used anode (negative electrode) is graphite, which in its fully lithiated state of LiC₆ correlates to a maximal capacity of 372 mAh/g. In the case of lithium titanate (Li₄Ti₅O₁₂) (“LTO”) batteries, the anode may alternatively include lithium titanate nanocrystals instead of carbon on the surface of the anode. The positive electrode (cathode) is generally one of the following materials: a layered oxide, such as lithium cobalt oxide (LiCoO₂), a polyanion, such as lithium iron phosphate (LiFePO₄) a spinel, such as lithium manganese oxide (LiMnO₂), a submicron or nanopowder form, as such lithium nickel dioxide (LiNiO₂) or lithium titanate (Li₄Ti₅O₁₂) (“LTO”). Graphene-containing electrodes (based on 2D and 3D structures of graphene) have also been used as components of electrodes for lithium batteries.

The electrolyte is typically a mixture of organic carbonates such as ethylene carbonate or diethyl carbonate containing complexes of lithium ions. These non-aqueous electrolytes generally use non-coordinating anion salts such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃).

Lithium-ion batteries may also include an electrode paste applied to the electrodes. When used in manufacture of the positive electrode film, the electrode paste composition typically contains a positive electrode active material, such as LiCoO₂, LiMnO₂, LiNiO₂, LiFePO₄, Li₄Ti₅₀₁₂ or mixture thereof. When used in manufacture of the negative electrode film, the electrode paste composition typically contains a negative electrode active material such as mesophase carbon micro beads (MCMB), natural graphite powder, or a mixture thereof. LTO batteries may alternatively include Li₄Ti₅₀₁₂ in the electrode paste applied to the anode.

Depending on materials choices, the voltage, energy density, life, and safety of a lithium-ion battery can change dramatically. Current effort has been exploring the use of novel architectures using nanotechnology to improve performance. Areas of interest include nano-scale electrode materials and alternative electrode structures. One of the greatest issues regarding safety is the propensity of lithium-ion batteries to overheat and sometime catch fire or violently explode. Lithium metal is a highly reactive alkali metal that, in the presence of air and moisture, spontaneously combusts. Thus, the electrodes and electrolyte in a lithium-ion battery must remain sealed against air and moisture. Failure and combustion can occur when one or more portions of the battery begin to bulge excessively after a number of recharging cycles, and the container develops a hole or otherwise fails, which is more common when the container is made of plastic. This exposes the highly reactive lithium metal in the anode to air and moisture, causing spontaneous combustion and/or explosion.

Accordingly, there remains a need to develop improved rechargeable batteries that are improved with respect to one or more of energy density, lifespan, speed and effectiveness of charge and discharge cycles, and safety.

### SUMMARY

It has now been found that incorporating metal (e.g., ground state gold or other noble metal) nanoparticles formed by laser ablation into the electrolyte and/or electrode paste applied to or in contact with the electrodes of a lithium-ion battery greatly improves performance of the battery, including improved charge density per unit size or weight, more efficient discharge and production of current, more efficient and faster recharge, and improved stability, longevity, and safety. The electrolyte in a lithium-ion battery is typically a gel or solid polymer electrolyte containing lithium salts.

In some embodiments, an improved electrolyte for use in manufacturing and/or restoring lithium-ion batteries comprises: a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles. A commonly used electrolyte polymer carrier is made by polymerizing poly(ethylene glycol) dimethacrylate (PEGDMA) and bis(2-methoxyethyl) ether (diglyme) in the presence of a free-radical initiator, such as methyl benzoylformate (MBF).

The concentration of metal nanoparticles in the improved electrolyte of a lithium-ion battery can be in a range of at least about 100 ppb and up to about 100 ppm, 50 ppm, 25 ppm, 10 ppm, 5 ppm, or 2 ppm.

In some embodiments, an improved cathode electrode paste for use in manufacturing and/or restoring lithium-ion batteries comprises a positive electrode active material such as one or more lithium metal oxides, such as LiCoO₂, LiMnO₂, LiMn₂O₄, Li₂MnO₃, LiNiO₂, LiFePO₄, LiNiMnCoO₂, Li₄Ti₅O₁₂ or mixture thereof, and ground state gold (or other noble metal) nanoparticles. An improved anode electrode paste for use in manufacturing and/or restoring lithium-ion batteries comprises a negative electrode active material such as mesophase carbon micro beads (MCMB), natural graphite powder, or a mixture thereof. LTO batteries may alternatively include Li₄Ti₅O₁₂ in the electrode paste applied to the anode. The electrode pastes include a binder, such as polyvinyl difluoride (PVDF), acrylic resin, styrene-butadiene rubber (SBR), a modified maleimide or mixture thereof, which is dispersed with the electrode active material in a solvent, such as N-methylpyrrolidone (NMP).

The concentration of metal nanoparticles in the improved electrode paste of a lithium-ion battery can be in a range of at least about 100 ppb and up to about 100 ppm, 50 ppm, 25 ppm, 10 ppm, 5 ppm, or 2 ppm.

In some embodiments, an improved lithium-ion battery comprises: an electrically insulated container; a positive electrode comprising lithium metal and graphite; a negative electrode comprising a lithium-metal oxide and metal oxide; and an electrolyte in contact with the electrodes comprising a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles. The improved lithium-ion battery may also comprise an electrode paste applied to the electrodes that also includes ground state gold (or other noble metal) nanoparticles.

In some embodiments, a method of manufacturing an improved lithium-ion battery comprises: (1) providing an electrolyte comprising a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles; (2) positioning the electrolyte between one or more negative electrodes comprising lithium metal and a solid protective carrier (e.g., graphite) and one or more positive electrodes comprising a lithium-metal oxide and metal oxide; (4) positioning the electrodes and electrolyte within an electrically insulated container, and (5) optionally placing an electrode paste comprising ground state gold (or other noble metal) nanoparticles on the electrodes. It should be understood that steps (1)-(5) can be performed in any order.

Improved lithium-ion batteries disclosed herein have one or more of the following characteristics compared to conventional lithium-ion batteries that do not include metal nanoparticles formed by laser ablation in the electrolyte and/or electrode paste: extended lifetime, higher energy density, improved safety, reduced cost, lower risk of fires and explosion, increased charging speed, increased discharging speed, higher fully charged resting voltage, increased partially discharged voltage, and increased reserve capacity. The inclusion of metal nanoparticles lowers the Gibbs-Helmholtz energy and promotes controlled crystallization of electroactive species to form smaller crystals rather than uncontrolled formation of large dendritic crystals after repeat discharging and charging cycles. This reduces the tendency of the insulated container to bulge and fracture as a result of otherwise uncontrolled dendritic crystallization of electroactive species in the electrolyte and/or electrodes. Reducing or preventing fracture of the insulating container greatly reduces or eliminates the propensity of lithium-ion batteries to combust or explode.

In preferred embodiments, the metal nanoparticles formed by laser ablation include gold or other noble metal nanoparticles. Some embodiments may additionally or alternatively include metal nanoparticles formed as alloys of any combination of gold, silver, platinum, and first row transition metals. The metal nanoparticles are preferably spherical-shaped but may optionally or alternatively include coral-shaped nanoparticles. Spherical nanoparticles are characterized as being free of external bond angles and are not hedron shaped. Coral-shaped nanoparticles are characterized as having a non-uniform cross section, a smooth surface, and a globular structure formed by multiple, non-linear strands joined together without right angles, with no edges or corners resulting from joining of separate planes.

Spherical nanoparticles can be less than 20 nm in diameter, preferably less than about 15 nm in diameter, more preferably less than about 10 nm in diameter, and most preferably less than about 7 nm in diameter (e.g., about 4 nm in diameter),

Coral-shaped nanoparticles typically have a mean length of less than about 100 nm, preferably less than about 80 nm, more preferably less than about 60 nm, and most preferably less than about 40 nm. Coral-shaped nanoparticles can have a mean length ranging from about 25 nm to about 80 nm.

Both spherical and coral-shaped metal nanoparticles can be formed by laser ablation, in contrast to chemical synthesis, to produce nanoparticles having a smooth surface with no external bond angles or edges, as opposed to a hedron-like or crystalline shape nanoparticles made by conventional chemical processes. In some embodiments, the nanoparticles have a narrow size distribution wherein at least about 99% of the nanoparticles are within 30%, 20%, or 10% of the mean length or diameter.

Additional features and advantages will be set forth in part in the description that follows, and in part will be obvious from the description, or may be learned by practice of the embodiments disclosed herein. It is to be understood that both the foregoing brief summary and the following detailed description are exemplary and explanatory only and are not restrictive of the embodiments disclosed herein or as claimed.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings, in which:

FIGS. 1A and 1B schematically illustrate a lithium-ion battery cell in a charged/discharging state and a discharged state, respectively;

FIG. 2 illustrates a lithium-ion battery cell showing buildup of crystallized electroactive species on electrode surfaces, which can at least partially block electrons or ions from passing to or from the electrodes;

FIG. 3 illustrates a lithium-ion battery cell having non-ionic, ground state, metal nanoparticles dispersed within the electrolyte for improving electron transport across the layer of crystallized buildup of electroactive species at the electrodes during a recharge cycle;

FIGS. 4A-4C show transmission electron microscope (TEM) images of coral-shaped nanoparticles for use in the electrode paste and/or electrolyte of a lithium-ion battery;

FIGS. 5A-5C show TEM images of exemplary spherical-shaped metal nanoparticles for use in electrode paste and/or electrolyte of a lithium-ion battery;

FIGS. 6A-6D show TEM images of various non-spherical nanoparticles that have surface edges and external bond angles made according to conventional chemical synthesis methods;

FIG. 7 is a graph that compares the discharge capacity of a conventional lithium-ion battery with the discharge capacity of the same type of battery that was modified to include the disclosed metal nanoparticles in the electrolyte and/or electrode paste;

FIG. 8 is a Nyquist plot that compares the impedance of a conventional lithium-ion battery with the impedance of the same type of battery that was modified to include the disclosed metal nanoparticles in the electrolyte and/or electrode paste; and

FIG. 9 is a Nyquist plot that compares the impedance of a lithium-ion battery modified to include the disclosed metal nanoparticles in the electrolyte and/or electrode paste before and after cycling through multiple charge and discharge cycles.

### DETAILED DESCRIPTION

### Introduction

Disclosed herein are improved electrolytes and electrode pastes used in the manufacture of lithium-ion batteries, improved lithium-ion batteries, and methods for manufacturing improved lithium-ion batteries.

In some embodiments, the disclosure relates to improved electrolytes and electrode pastes for use in manufacturing rechargeable batteries such as lithium-ion batteries, improved lithium-ion batteries made therewith, and methods for manufacturing improved lithium-ion batteries. Improved lithium-ion batteries incorporating improved electrolytes and electrode pastes disclosed herein have one or more of the following characteristics compared to conventional lithium-ion batteries that do not include metal nanoparticles formed by laser ablation in the electrolyte or electrode paste: extended lifetime, higher energy density, improved safety, reduced cost, lower risk of fires and explosion, increased charging speed, increased discharging speed, higher fully charged resting voltage, increased partially discharged voltage, and increased reserve capacity.

Including ground state metal (e.g., gold) nanoparticles in the electrolyte and/or electrode paste of a lithium-ion battery improves performance for various reasons. The metal nanoparticles form nucleation sites that promote formation of smaller electroactive species, such as lithium-metal oxide crystals, in lithium-ion batteries.

The smaller lithium-metal oxide crystals are softer, more stable, and more porous than lithium-metal oxide crystals formed in conventional lithium-ion batteries. The inclusion of the metal nanoparticles in the electrolyte and/or electrode paste greatly reduces the tendency of lithium-ion batteries to bulge, which greatly reduces the possibility of fracturing the encasement, which is critical to avoid spontaneous fires and explosion of the highly reactive lithium metal. This increases the lifetime, energy density, safety, charging speed, discharge speed, and reserve capacity, and reduces the cost of lithium-ion batteries.

The improved performance of rechargeable batteries using metal nanoparticles in the electrolyte and/or electrode paste facilitates the design of new battery types that are reduced in size but have the same or increased charge density. This permits the manufacture of batteries that are not overdesigned to avoid typical problems. The metal nanoparticles enhance the performance of electroactive species in the battery. The metal nanoparticles are unique in that they have allotropic surfaces, which are stronger than chemically formed nanoparticles. The metal nanoparticles lower the Gibbs energy and reduces or eliminates formation of large dendritic crystals of electroactive species.

The resulting lithium-ion batteries have greater consistency of performance.

### Overview of Rechargeable Lithium-Ion Batteries

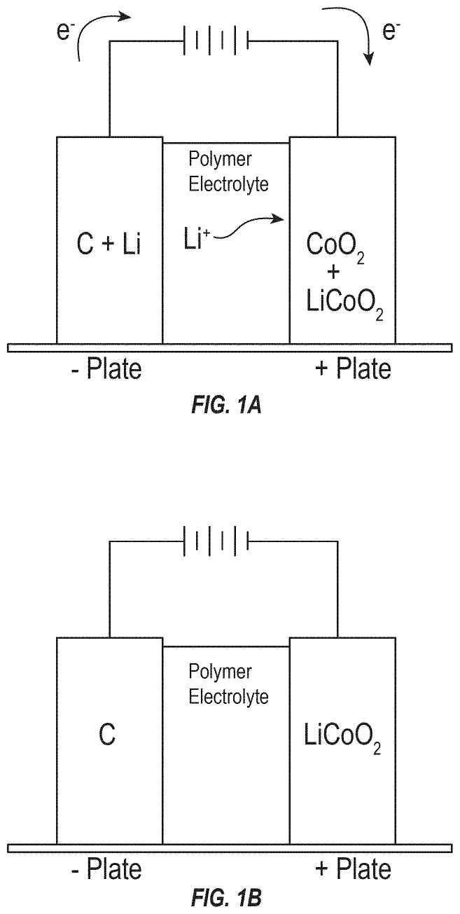

FIG. 1A schematically illustrates a typical lithium-ion battery cell in a charged/actively discharging state. At the negative electrode, the electrode typically includes lithium metal intercalated with layers of graphite, while at the positive electrode, the electrode consists essentially of a lithium-metal oxide intercalated with the layers of metal oxide. The electrolyte is typically a lithium salt in an organic solvent/polymer and is in contact with the positive and negative electrode plates. The electrolyte can be a liquid, gel, or semi-solid polymer.

Examples of lithium-metal oxides that can be used for the positive electrode (cathode) include lithium-cobalt oxide (LiCoO₂), lithium-iron phosphate (LiFePO₄), spinel lithium-manganese oxide (LiMn₂O₄), layered lithium-manganese oxide (Li₂MnO₃)-based lithium rich layered materials (LMR-NMC), layered lithium-manganese oxide (LiMnO₂), lithium nickel dioxide (LiNiO₂), lithium-nickel-manganese-cobalt oxide (LiNiMnCoO₂ or NMC), lithium titanate (Li₄Ti₅O₁₂) (“LTO”), and combinations thereof.

The negative electrode (anode) typically comprises lithium metal intercalated with graphite. Graphite in a fully lithiated state can be represented as LiC₆. In the case of lithium titanate (LTO) batteries, the anode may alternatively include lithium titanate nanocrystals instead of carbon on the surface of the anode.

Examples of electrolytes include a mixture of organic carbonates, such as ethylene carbonate or diethyl carbonate containing complexes of lithium ions. These non-aqueous electrolytes generally use non-coordinating anion salts such as lithium hexafluorophosphate (LiPF₆), lithium hexafluoroarsenate monohydrate (LiAsF₆), lithium perchlorate (LiC₁₀₄), lithium tetrafluoroborate (LiBF₄), and lithium triflate (LiCF₃SO₃). Improved electrolytes include gold or other metal nanoparticles as disclosed herein.

Examples of cathode electrode paste include a positive electrode active material, such as one or more lithium metal oxides, such as LiCoO₂, LiMnO₂, LiMn₂O₄, Li₂MnO₃, LiNiO₂, LiFePO₄, LiNiMnCoO₂, Li₄Ti₅O₁₂ or mixture thereof, and ground state gold (or other noble metal) nanoparticles. Examples of anode electrode paste include a negative electrode active material, such as mesophase carbon micro beads (MCMB), natural graphite powder, or a mixture thereof. LTO batteries may include Li₄Ti₅O₁₂ in the electrode paste applied to the anode. Electrode pastes can include a binder, such as polyvinyl difluoride (PVDF), acrylic resin, styrene-butadiene rubber (SBR), a modified maleimide or mixture thereof, which is dispersed with the electrode active material in a solvent, such as N-methylpyrrolidone (NMP).

The reactants in the electrochemical reactions in a lithium-ion cell include materials of the anode and cathode, both of which are compounds containing lithium atoms and may include electrode paste applied thereto. During discharge, an oxidation half-reaction at the anode produces positively charged lithium ions and negatively charged electrons. The oxidation half-reaction may also produce uncharged material that remains at the anode. Lithium ions move through the electrolyte, electrons move through the external circuit, and then they recombine at the cathode (together with the cathode material) in a reduction half-reaction.

The electrolyte and external circuit provide conductive media for lithium ions and electrons, respectively, but do not partake in the electrochemical reaction. During discharge, electrons flow from the negative electrode (anode) towards the positive electrode (cathode) through the external circuit. The reactions during discharge lower the chemical potential of the cell, so discharging transfers energy from the cell to wherever the electric current dissipates its energy, mostly in the external circuit. During charging, these reactions and transports go in the opposite direction: electrons move from the positive electrode to the negative electrode through the external circuit, and lithium ions move from the positive electrode through the electrolyte back to the negative electrode, where they are reduced back to ground state lithium. To charge the cell, the external circuit has to provide electric energy. This energy is then stored as chemical energy in the cell (with some loss, e.g., due to coulombic efficiency lower than 1).

Both electrodes allow lithium ions to move in and out of their structures with a process called insertion (intercalation) or extraction (deintercalation), respectively. As the lithium ions “rock” back and forth between the two electrodes, these batteries are also known as “rocking-chair batteries” or “swing batteries”. The following equations exemplify the chemistry.

The negative electrode (anode) half-reaction in a lithium-doped graphite substrate (which is reversed during charging) is:

LiC₆→C₆+Li⁺+e⁻

The positive electrode (cathode) half-reaction during discharge in a lithium-doped cobalt oxide substrate (which is reversed during charging) is:

CoO₂+Li⁺+e⁻→LiCoO₂

The full reaction (left to right during discharge, right to left when charging) is:

LiC₆+CoO₂↔C₆+LiCoO₂

The overall reaction has its limits. Overdischarging supersaturates lithium cobalt (or other metal) oxide, leading to the production of lithium (or other metal) oxide, possibly by the following irreversible reaction:

Li⁺+e⁻+LiCoO₂→Li₂O+CoO

Overcharging up to 5.2 volts leads to the synthesis of cobalt(IV) oxide, as evidenced by x-ray diffraction:

LiCoO₂→Li⁺+CoO₂+e⁻

In a lithium-ion battery that is based on lithium cobalt oxide, for example, the lithium ions are transported to and from the positive or negative electrodes by oxidizing the transition metal, cobalt (Co), in Li₁₋ₓCoO₂ from Co³⁺ to Co⁴⁺ during charge, and reducing Co′ to Co′ during discharge. The cobalt electrode reaction is only reversible for x<0.5 (x in mole units), limiting the depth of discharge allowable. Similar oxidation-reduction reactions occur when other lithium-metal oxide materials are used in the positive electrode.

The cell's energy is equal to the voltage times the charge. Each gram of lithium represents Faraday's constant/6.941, or 13,901 coulombs. At 3 V, this gives 41.7 kJ per gram of lithium, or 11.6 kWh per kilogram of lithium. This is a bit more than the heat of combustion of gasoline but does not consider the other materials that go into a lithium battery, which makes lithium batteries many times heavier per unit of energy.

Incorporating metal nanoparticles into the electrolyte and/or electrode paste of a lithium-ion battery can enhance the beneficial reactions and at least partially ameliorate many of the problems associated with lithium-ion batteries.

FIG. 1B illustrates the lithium-ion battery cell in the discharged state. As shown, the anode is depleted in lithium metal, and the cathode is enriched with lithium ions. Recharging the battery involves applying sufficient voltage to the electrolyte and running the circuit in the reverse of that shown in FIG. 1A, thereby bringing the negative electrode plate toward a greater proportion of reduced (ground state) lithium and the positive electrode plate toward a lower proportion of lithium ions. The electrolyte is designed to not significantly accumulate lithium ions during charge and discharge. The electrode paste can exchange lithium ions with the electrodes as well.

In lithium-ion batteries, dendritic crystals of electroactive species can form in various parts of the battery, including the cathode, electrolyte and electrode paste, which can cause various forms of damage, as discussed herein. These include irreversible degradation of the cathode and/or bulging of the battery casing. Rupture of the casing can expose the anode, containing lithium metal, to air and moisture, resulting in spontaneous combustion and/or explosion. Inclusion of metal nanoparticles as disclosed herein within the electrolyte and/or electrode paste can greatly reduce problems associated with dendritic crystal formation, battery “memory”, and irreversible degradation of electrodes.

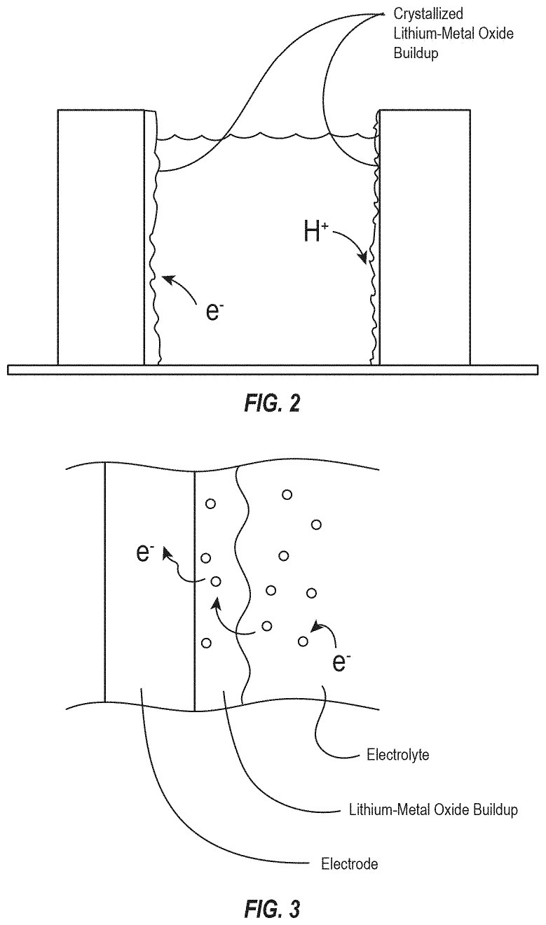

FIG. 2 schematically illustrates buildup of crystalline electroactive species (e.g., lithium-metal oxide) on the electrodes of a lithium-ion battery. In a newer battery, solid electroactive species formed on the electrode plates are more amorphous and more easily revert back to electrode materials and electrolyte as a voltage is applied and the battery is recharged. Through multiple cycles of charge and discharge, however, some of the electroactive species will not be recombined into the electrolyte, electrode paste, and/or electrodes and will begin to form a more stable, crystalline form on the electrodes. Over time, electroactive species buildup reduces the ability of electrons and ions to pass to and from the working electrode surfaces, increasing internal resistance of the battery cell and decreasing its capacity. In addition, the buildup of this hard, stable and dendritic crystalline form of electroactive species can eventually cause the battery to bulge, which is associated with dying, dead or highly depleted batteries.

FIG. 3 schematically illustrates a plurality of nonionic, ground state metal nanoparticles in the electrolyte of a lithium-ion battery cell. Without wishing to be bound to any particular theory, it is postulated that a portion of the nanoparticles are able to move into the layer of crystalline electroactive species (e.g., lithium-metal oxide) buildup and maintain open regions of the electrode where buildup of crystalline electroactive species crystals is prevented or reduced. The nanoparticles within the bulk electrolyte and within the layer of crystalline electroactive species buildup are able to improve electron transport through or across the layer of the crystalline electroactive species buildup and to the working surface of the electrode. In the case of lithium-ion batteries, the nanoparticles within the electrolyte prevent the formation and buildup of dendritic crystals from electroactive species. Instead, the nanoparticles promote formation of smaller crystals that more easily revert back to mobile electroactive species.

It is theorized that during recharging of a lithium-ion battery, the nanoparticles potentiate the release of Li⁺ ions from solid lithium-metal oxide in the positive electrode (the cathode during discharge and the anode during recharge), which are transported through the electrolyte to reform lithium metal in the negative electrode (the anode during discharge and the cathode during recharge). It is believed that the nanoparticles are able to bring about the dissolution of crystallized electroactive species responsible for detrimental buildup, bulging, and battery degradation. Thus, it is theorized that the nanoparticles can both: (1) aid in electron transport through or across a crystalline layer, and (2) aid in slowing or preventing the formation, or promoting the disassociation, of crystalline deposits over time.

Lithium-ion batteries manufactured using an electrolyte and/or electrode paste containing the metal nanoparticles described herein were surprisingly and unexpectedly found to have increased charge density, increased fully charged resting voltage, increased partially discharged voltage, increased amps, increased discharging rate, increased charging rate, increased safety, and increased reserve capacity. In some cases, some of the metal nanoparticles in the electrolyte and/or electrode paste of a lithium-ion battery may become incorporated in the electrodes themselves.

In some embodiments, the metal nanoparticles are or include spherical nanoparticles. As used herein, the spherical-shaped nanoparticles are not the same as the hedron-like, multi-edged particles formed through a conventional chemical synthesis method. Rather, spherical-shaped nanoparticles are formed through a laser-ablation process that results in a smooth surface without edges.

In some embodiments, the metal nanoparticles can include coral-shaped metal nanoparticles. As used herein, the term “coral-shaped nanoparticles” refers to nanoparticles that have a non-uniform cross section, a smooth surface, and a globular structure formed by multiple, non-linear strands joined together without right angle and with no edges or corners resulting from joining of separate planes. This is in contrast to nanoparticles made through a conventional chemical synthesis method, which yields particles having a hedron-like shape with crystalline faces and edges, and which can agglomerate to form “flower-shaped” particles.

The relative smoothness of the surfaces of the spherical- and/or coral-shaped nanoparticles described herein beneficially enables the formation of very stable and highly efficient electrolytes in lithium-ion batteries. Such nanoparticles can be stored in solution (e.g., at room temperature) for months or even years (e.g., 1 to 2 years, up to 3 years or more, up to 5 years or more) with little to no agglomeration or degradation in particle size distribution.

The smooth, non-angular shape of the nanoparticles described herein yield smaller and less dendritic crystals of electroactive species in lithium-ion batteries, which cause greatly reduced bulging, greatly increasing longevity and safety.

Preferred embodiments utilize spherical-shaped, ground state gold nanoparticles, though other materials may additionally or alternatively be utilized as well. For example, some embodiments may additionally or alternatively include nanoparticles formed from alloys of gold, silver, platinum, first row transition metals, or combinations thereof. Other exemplary metals are described below.

### Nanoparticle Configurations

In some embodiments, the metal nanoparticles may comprise or consist essentially of nonionic, ground state metal nanoparticles. Examples include spherical-shaped metal nanoparticles, coral-shaped metal nanoparticles, or a blend of spherical-shaped metal nanoparticles and coral-shaped metal nanoparticles.

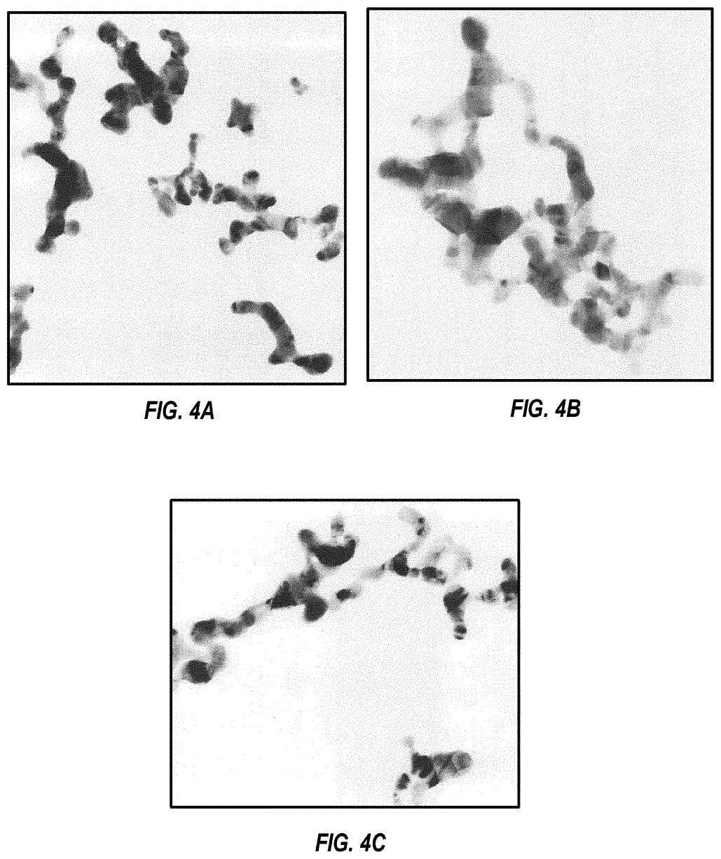

In some embodiments, nonionic metal nanoparticles useful for making nanoparticle compositions comprise coral-shaped nanoparticles (see FIGS. 4A-4C). The term “coral-shaped metal nanoparticles” refers to nanoparticles that are made from one or more metals, preferably nonionic, ground state metals having a non-uniform cross section and a globular structure formed by multiple, non-linear strands joined together without right angles. Similar to spherical-shaped nanoparticles, coral-shaped nanoparticles may have only internal bond angles and no external edges or bond angles. In this way, coral-shaped nanoparticles can be highly resistant to ionization, highly stable, and highly resistance to agglomeration. Such coral-shaped nanoparticles can exhibit a high ζ-potential, which permits the coral-shaped nanoparticles to remain dispersed within a polar solvent without a surfactant, which is a surprising and unexpected result.

In some embodiments, coral-shaped nanoparticles can have a mean length of less than about 100 nm, preferably less than about 80 nm, more preferably less than about 60 nm, and most preferably less than about 40 nm. Coral-shaped nanoparticles can have a mean length ranging from about 25 nm to about 80 nm. In other embodiments, coral-shaped nanoparticles can have lengths ranging from about 15 nm to about 100 nm, or about 20 nm to about 90 nm, or about 25 nm to about 80 nm, or about 30 nm to about 75 nm, or about 40 nm to about 70 nm.

In some embodiments, coral-shaped nanoparticles can have a particle size distribution such that at least 99% of the nanoparticles have a length within 30% of the mean length, or within 20% of the mean length, or within 10% of the mean length. In some embodiments, coral-shaped nanoparticles can have a ζ-potential of at least 10 mV, preferably at least about 15 mV, more preferably at least about 20 mV, even more preferably at least about 25 mV, and most preferably at least about 30 mV.

Examples of methods and systems for manufacturing coral-shaped nanoparticles through a laser-ablation process are disclosed in U.S. Pat. No. 9,919,363, which is incorporated herein by reference.

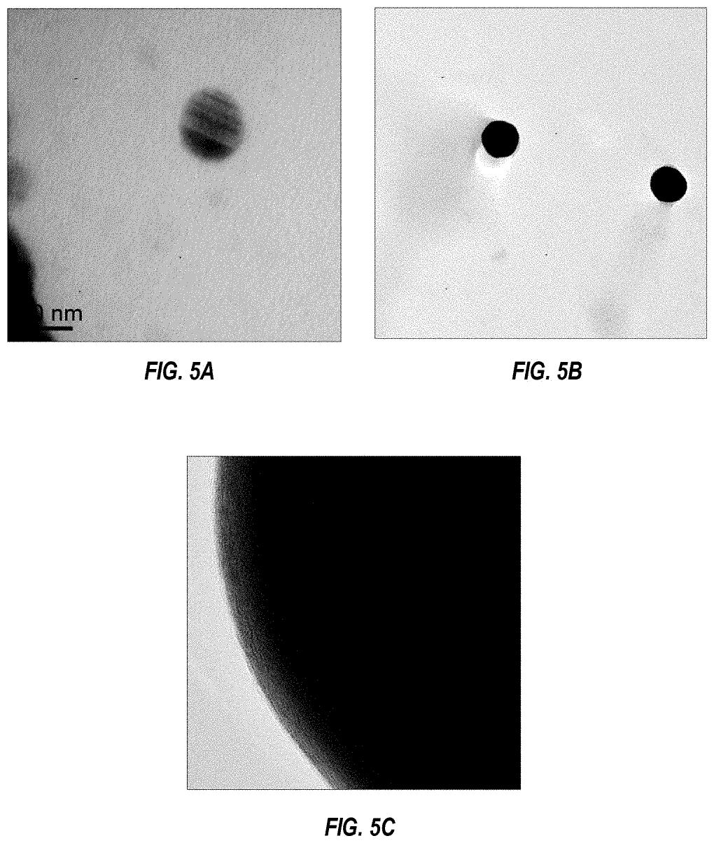

In some embodiments, metal nanoparticles useful for making nanoparticle compositions may comprise spherical nanoparticles instead of, or in addition to, coral-shaped nanoparticles. FIGS. 5A-5C show transmission electron microscope (TEM) images of spherical-shaped nanoparticles utilized in embodiments of the present disclosure. FIG. 5A shows a gold/silver alloy nanoparticle (90% silver and 10% gold by molarity). FIG. 5B shows two spherical nanoparticles side by side to visually illustrate size similarity. FIG. 5C shows a surface of a metal nanoparticle showing the smooth and edgeless surface morphology.

Spherical-shaped metal nanoparticles preferably have solid cores. The term “spherical-shaped metal nanoparticles” refers to nanoparticles that are made from one or more metals, preferably nonionic, ground state metals, having only internal bond angles and no external edges or bond angles. In this way, the spherical nanoparticles are highly resistant to ionization, highly stable, and highly resistance to agglomeration. Such nanoparticles can exhibit a high ζ-potential, which permits the spherical nanoparticles to remain dispersed within a polar solvent without a surfactant, which is a surprising and unexpected result.

In some embodiments, spherical-shaped metal nanoparticles can have a diameter of about 40 nm or less, about 35 nm or less, about 30 nm or less, about 25 nm or less, about 20 nm or less, about 15 nm or less, about 10 nm or less, about 7.5 nm or less, or about 5 nm or less. Spherical-shaped nanoparticles can have a mean diameter of less than about 20 nm in diameter, preferably less than about 15 nm in diameter, more preferably less than about 10 nm in diameter, and most preferably less than about 7 nm in diameter.

In some embodiments, spherical-shaped nanoparticles can have a particle size distribution such that at least 99% of the nanoparticles have a diameter within 30% of the mean diameter of the nanoparticles, or within 20% of the mean diameter, or within 10% of the mean diameter. In some embodiments, spherical-shaped nanoparticles can have a mean diameter and at least 99% of the nanoparticles have a diameter that is within ±3 nm of the mean diameter, ±2 nm of the mean diameter, or ±1 nm of the mean diameter. In some embodiments, spherical-shaped nanoparticles can have a ζ-potential (measured as an absolute value) of at least 10 mV, preferably at least about 15 mV, more preferably at least about 20 mV, even more preferably at least about 25 mV, and most preferably at least about 30 mV.

Examples of methods and systems for manufacturing spherical-shaped nanoparticles through a laser-ablation process are disclosed in U.S. Pat. No. 9,849,512, incorporated herein by this reference.

The metal nanoparticles, including coral-shaped and/or spherical-shaped nanoparticles, may comprise any desired metal, mixture of metals, or metal alloy, including at least one of gold, silver, platinum, palladium, rhodium, osmium, ruthenium, rhodium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, or alloys thereof.

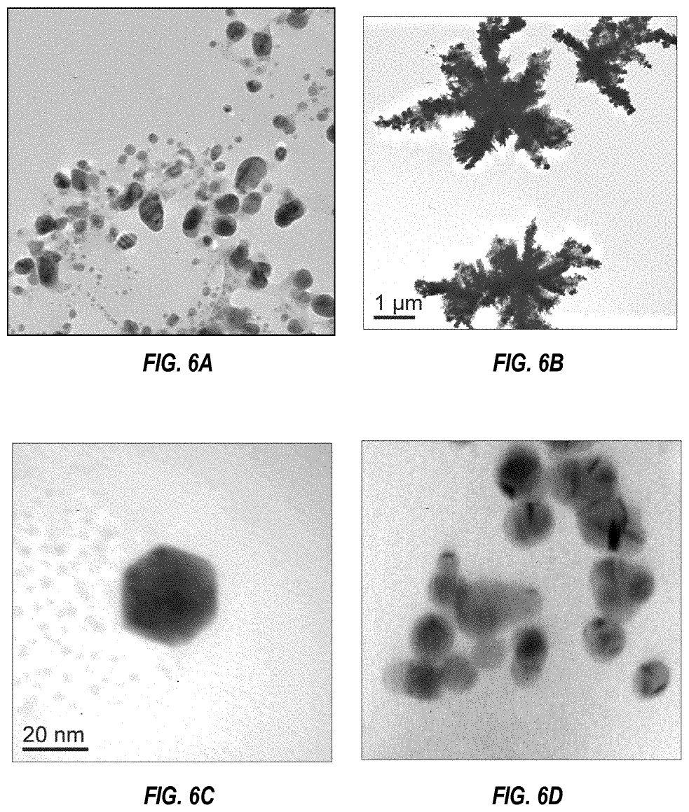

In contrast to coral-shaped and spherical-shaped nanoparticles as used herein, FIGS. 6A-6D show TEM images of nanoparticles made according to various chemical synthesis methods. As shown, the nanoparticles formed using these various chemical synthesis methods tend to exhibit a clustered, crystalline, or hedron-like shape rather than a true spherical shape with round and smooth surfaces. Some refer to such three-dimensional structures as “nanoflowers”. However, nanoflowers do not fit the definition of “coral-shaped” nanoparticles.

FIG. 6A shows silver nanoparticles formed using a common trisodium citrate method. The nanoparticles are clustered and have a relatively broad size distribution. FIG. 6B shows another set of silver nanoparticles (available from American Biotech Labs, LLC) formed using another chemical synthesis method and showing rough surface morphologies with many edges. FIG. 6C shows a gold nanoparticle having a hedron shape as opposed to a truly spherical shape. FIG. 6D shows a set of silver nanoparticles (sold under the trade name MesoSilver), which have relatively smoother surface morphologies but are understood to be shells of silver formed over a non-metallic seed material.

In contrast, the spherical-shaped nanoparticles described herein are solid metal, substantially unclustered, optionally exposed/uncoated, and have a smooth and round surface morphology along with a narrow size distribution. Similar to spherical-shaped nanoparticles, coral-shaped nanoparticles have only internal bond angles and no external edges or bond angles. Stated differently, such coral-shaped nanoparticles do not have lattice planes or crystalline faces, nor do they depend on crystalline growth based on such structures. This is in contrast to other nanoparticle morphologies such as “nanoflowers” (see, e.g., Sahu et al., “Flower Shaped Nanostructures: An Efficient Bacteria Exterminator” A Search for Antibacterial Agents, Chapter 2, 2007; 73(6): 1712-1720), which include a face centered cubic structure with specified lattice planes. Thus, the term “coral-shaped nanoparticles” excludes the “nanoflowers” disclosed in Sahu et al

In some embodiments, coral-shaped metal nanoparticles can be used together with spherical-shaped metal nanoparticles. In general, spherical-shaped metal nanoparticles can be smaller than coral-shaped metal nanoparticles and in this way can provide very high surface area for catalyzing desired reactions or providing other desired benefits. On the other hand, the generally larger coral-shaped nanoparticles can exhibit higher surface area per unit mass compared to spherical-shaped nanoparticles because coral-shaped nanoparticles have internal spaces and surfaces rather than a solid core and only an external surface. In some cases, providing nanoparticle compositions containing both coral-shaped and spherical-shaped nanoparticles can provide synergistic results. For example, coral-shaped nanoparticles can help carry and/or potentiate the activity of spherical-shaped nanoparticles in addition to providing their own unique benefits.

In some embodiments, a nanoparticle composition may comprise (1) a first set of metal nanoparticles having a specific particle size and particle size distribution, (2) and second set of metal nanoparticles having a specific particle size and particle size distribution, and (3) a carrier.

### Improved Lithium-Ion Batteries Incorporating Metal Nanoparticles

Incorporating metal (e.g., ground state gold or other noble metal) nanoparticles formed by laser ablation into the electrolyte and/or electrode paste applied to or in contact with the electrodes of a lithium-ion battery greatly improves performance of the battery, including improved charge density per unit size or weight, more efficient discharge and production of current, more efficient and faster recharge, and improved stability, longevity, and safety. The electrolyte in a lithium-ion battery is typically a gel or solid polymer electrolyte containing lithium salts.

In some embodiments, an improved electrolyte for use in manufacturing and/or restoring lithium-ion batteries comprises: a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles. A commonly used electrolyte polymer carrier is made by polymerizing poly(ethylene glycol) dimethacrylate (PEGDMA) and bis(2-methoxyethyl) ether (diglyme) in the presence of a free-radical initiator, such as methyl benzoylformate (MBF).

The concentration of metal nanoparticles in the improved electrolyte of a lithium-ion battery can be in a range of at least about 100 ppb and up to about 100 ppm, 50 ppm, 25 ppm, 10 ppm, 5 ppm, or 2 ppm.

In some embodiments, an improved cathode electrode paste for use in manufacturing and/or restoring lithium-ion batteries comprises a positive electrode active material such as one or more lithium metal oxides, such as LiCoO₂, LiMnO₂, LiMn₂O₄, Li₂MnO₃, LiNiO₂, LiFePO₄, LiNiMnCoO₂, Li₄Ti₅O₁₂ or mixture thereof, and ground state gold (or other noble metal) nanoparticles. An improved anode electrode paste for use in manufacturing and/or restoring lithium-ion batteries comprises a negative electrode active material such as mesophase carbon micro beads (MCMB), natural graphite powder, or a mixture thereof. LTO batteries may alternatively include Li₄Ti₅O₁₂ in the electrode paste applied to the anode. The electrode pastes include a binder, such as polyvinyl difluoride (PVDF), acrylic resin, styrene-butadiene rubber (SBR), a modified maleimide or mixture thereof, which is dispersed with the electrode active material in a solvent, such as N-methylpyrrolidone (NMP).

The concentration of metal nanoparticles in the improved electrode paste of a lithium-ion battery can be in a range of at least about 100 ppb and up to about 100 ppm, 50 ppm, 25 ppm, 10 ppm, 5 ppm, or 2 ppm. In preferred embodiments, the concentration of metal nanoparticles in the improved electrode paste of a lithium-ion battery will be similar to or the same as the concentration of metal nanoparticles in the improved electrolyte. In this way, the concentration of metal nanoparticles will remain the same in both the electrolyte and electrode paste and will not appreciably change as a result of nanoparticle migration between the electrolyte and electrode paste.

In some embodiments, an improved lithium-ion battery comprises: an electrically insulated container; a positive electrode comprising lithium metal and graphite; a negative electrode comprising a lithium-metal oxide and metal oxide; and an electrolyte in contact with the electrodes comprising a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles. The improved lithium-ion battery may also comprise an electrode paste applied to the electrodes that also includes ground state gold (or other noble metal) nanoparticles.

In some embodiments, a method of manufacturing an improved lithium-ion battery comprises: (1) providing an electrolyte comprising a polymer carrier, one or more lithium salts, such as lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃), and ground state gold (or other noble metal) nanoparticles; (2) positioning the electrolyte between one or more negative electrodes comprising lithium metal and a solid protective carrier (e.g., graphite) and one or more positive electrodes comprising a lithium-metal oxide and metal oxide; (4) positioning the electrodes and electrolyte within an electrically insulated container, and (5) optionally placing an electrode paste comprising ground state gold (or other noble metal) nanoparticles on the electrodes. It should be understood that steps (1)-(5) can be performed in any order.

Improved lithium-ion batteries disclosed herein have one or more of the following characteristics compared to conventional lithium-ion batteries that do not include metal nanoparticles formed by laser ablation in the electrolyte: extended lifetime, higher energy density, improved safety, reduced cost, lower risk of fires and explosion, increased charging speed, increased discharging speed, higher fully charged resting voltage, increased partially discharged voltage, and increased reserve capacity. The inclusion of metal nanoparticles lowers the Gibbs-Helmholtz energy and promotes controlled crystallization of electroactive species to form smaller crystals rather than uncontrolled formation of large dendritic crystals after repeat discharging and charging cycles. This reduces the tendency of the insulated container to bulge and fracture as a result of otherwise uncontrolled dendritic crystallization of electroactive species in the electrolyte and/or electrodes. Reducing or preventing fracture of the insulating container greatly reduces or eliminates the propensity of lithium-ion batteries to combust or explode.

In preferred embodiments, the metal nanoparticles formed by laser ablation include gold or other noble metal nanoparticles. Some embodiments may additionally or alternatively include metal nanoparticles formed as alloys of any combination of gold, silver, platinum, and first row transition metals. The metal nanoparticles are preferably spherical-shaped but may optionally or alternatively include coral-shaped nanoparticles. Spherical nanoparticles are characterized as being free of external bond angles and are not hedron shaped. Coral-shaped nanoparticles are characterized as having a non-uniform cross section, a smooth surface, and a globular structure formed by multiple, non-linear strands joined together without right angles, with no edges or corners resulting from joining of separate planes.

Spherical nanoparticles can be less than 20 nm in diameter, preferably less than about 15 nm in diameter, more preferably less than about 10 nm in diameter, and most preferably less than about 7 nm in diameter (e.g., about 4 nm in diameter),

Coral-shaped nanoparticles typically have a mean length of less than about 100 nm, preferably less than about 80 nm, more preferably less than about 60 nm, and most preferably less than about 40 nm. Coral-shaped nanoparticles can have a mean length ranging from about 25 nm to about 80 nm.

Both spherical and coral-shaped metal nanoparticles can be formed by laser ablation, in contrast to chemical synthesis, to produce nanoparticles having a smooth surface with no external bond angles or edges, as opposed to a hedron-like or crystalline shape nanoparticles made by conventional chemical processes. In some embodiments, the nanoparticles have a narrow size distribution wherein at least about 99% of the nanoparticles are within 30%, 20%, or 10% of the mean length or diameter.

### EXAMPLES

### Example 1

An improved electrolyte for use in lithium-ion batteries is made by adding gold nanoparticles to the solid or gel electrolyte (i.e., spherical-shaped gold nanoparticles having a mean diameter of 4 nm). The concentration of spherical-shaped gold nanoparticles in the electrolyte is 2 ppm. The gold nanoparticles in the electrolyte improve various aspects of the lithium-ion battery, including improved charge density per unit size or weight, more efficient discharge and production of current, more efficient and faster recharge, and improved stability, longevity, and safety.

### Example 2

An improved cathode paste for use in lithium-ion batteries is made by adding gold nanoparticles to the cathode paste (i.e., spherical-shaped gold nanoparticles having a mean diameter of 4 nm). The concentration of spherical-shaped gold nanoparticles in the cathode paste is 2 ppm. The cathode paste includes a positive electrode active material selected from LiCoO₂, LiMnO₂, LiMn₂O₄, Li₂MnO₃, LiNiO₂, LiFePO₄, LiNiMnCoO₂, Li₄Ti₅O₁₂ and mixture thereof. The cathode paste includes a binder such as polyvinyl difluoride (PVDF), acrylic resin, styrene-butadiene rubber (SBR), a modified maleimide or mixture thereof, which is dispersed with the electrode active material in a solvent, such as N-methylpyrrolidone (NMP).

The gold nanoparticles in the cathode paste improve various aspects of the lithium-ion battery, including improved charge density per unit size or weight, more efficient discharge and production of current, more efficient and faster recharge, and improved stability, longevity, and safety.

### Example 3

An improved anode paste for use in lithium-ion batteries is made by adding gold nanoparticles to the anode paste (i.e., spherical-shaped gold nanoparticles having a mean diameter of 4 nm). The concentration of spherical-shaped gold nanoparticles in the anode paste is 2 ppm. The anode paste includes a negative electrode active material selected from such as mesophase carbon micro beads (MCMB), natural graphite powder, Li₄Ti₅O₁₂, and mixtures thereof. The anode paste includes a binder such as polyvinyl difluoride (PVDF), acrylic resin, styrene-butadiene rubber (SBR), a modified maleimide or mixture thereof, which is dispersed with the electrode active material in a solvent, such as N-methylpyrrolidone (NMP).

The gold nanoparticles in the anode paste improve various aspects of the lithium-ion battery, including improved charge density per unit size or weight, more efficient discharge and production of current, more efficient and faster recharge, and improved stability, longevity, and safety.

### Example 4

An improved lithium-ion battery comprises: one or more positive electrodes comprising lithium-cobalt oxide (LiCoO₂) intercalated with layers of cobalt oxide; one or more negative electrodes comprising ground state lithium metal) (Li⁰) intercalated with layers of graphite to form a fully lithiated negative electrode having the general formula LiC₆; an electrolyte between and/or in contact with the positive and negative electrodes comprising a mixture of organic carbonates, including ethylene carbonate and/or diethyl carbonate containing complexes of lithium ions. one or more non-coordinating anion salts, including lithium hexafluorophosphate (LiPF₆), lithium hexafluoroarsenate monohydrate (LiAsF₆), lithium perchlorate (LiClO₄), lithium tetrafluoroborate (LiBF₄), or lithium triflate (LiCF₃SO₃), and spherical-shaped gold nanoparticles having a mean diameter of 4 nm and concentration of 2 ppm dispersed throughout the electrolyte; and a container comprising metal and/or plastic encasing the positive electrode(s), negative electrode(s), and electrolyte.

### Example 5

An improved lithium-ion battery is made by modifying the cathode in Example 4 to include one or more of the following lithium-metal oxides instead of or in addition to lithium-cobalt oxide (LiCoO₂): lithium-iron phosphate (LiFePO₄), spinel lithium-manganese oxide (LiMn₂O₄), layered lithium-manganese oxide (Li₂MnO₃)-based lithium rich layered material (LMR-NMC), layered lithium-manganese oxide (LiMnO₂), lithium nickel dioxide (LiNiO₂), lithium-nickel-manganese-cobalt oxide (LiNiMnCoO₂ or NMC), lithium titanate (Li₄Ti₅O₁₂).

### Example 6

A further improved lithium-ion battery is made by modifying the improved lithium-ion battery of Example 4 or Example 5 to incorporate an electrode paste applied to the cathode and/or anode that includes spherical-shaped gold nanoparticles having a mean diameter of 4 nm and concentration of 2 ppm dispersed throughout the electrode paste. The electrode paste can be a cathode paste according to Example 2 and/or anode paste according to Example 3.

### Example 7

A method of manufacturing an improved lithium-ion battery comprises: (1) providing one or more positive electrodes comprising lithium-metal oxide, such as lithium-cobalt oxide (LiCoO₂), intercalated with layers of metal oxide, such as cobalt oxide; (2) providing one or more negative electrodes comprising ground state lithium metal)(Li⁰) intercalated with layers of graphite to form a fully lithiated negative electrode having the general formula LiC₆; (3) providing an electrolyte between and/or in contact with the positive and negative electrodes comprising a mixture of organic carbonates, including ethylene carbonate and/or diethyl carbonate containing complexes of lithium ions and one or more non-coordinating anion salts, including lithium hexafluorophosphate (LiPF₆), lithium hexafluoroarsenate monohydrate (LiAsF₆), lithium perchlorate (LiClO₄), lithium tetrafluoroborate (LiBF₄), or lithium triflate (LiCF₃SO₃); (4) positioning the positive electrode(s), negative electrode(s), and electrolyte within an electrically insulated container, with the electrolyte being in between and/or in contact with the positive and negative electrodes, and (5) adding gold nanoparticles to the solid or gel electrolyte (e.g., spherical-shaped gold nanoparticles having a mean diameter of 4 nm), either before or after placing the electrolyte within the electrically insulated container.

### Example 8

The method of manufacturing an improved lithium-ion battery of Example 7 is modified by modifying the cathode in Example 7 to include one or more of the following lithium-metal oxides instead of or in addition to lithium-cobalt oxide (LiCoO₂): lithium-iron phosphate (LiFePO₄), spinel lithium-manganese oxide (LiMn₂O₄), layered lithium-manganese oxide (Li₂MnO₃)-based lithium rich layered material (LMR-NMC), layered lithium-manganese oxide (LiMnO₂), lithium nickel dioxide (LiNiO₂), lithium-nickel-manganese-cobalt oxide (LiNiMnCoO₂ or NMC), lithium titanate (Li₄Ti₅O₁₂).

### Example 9

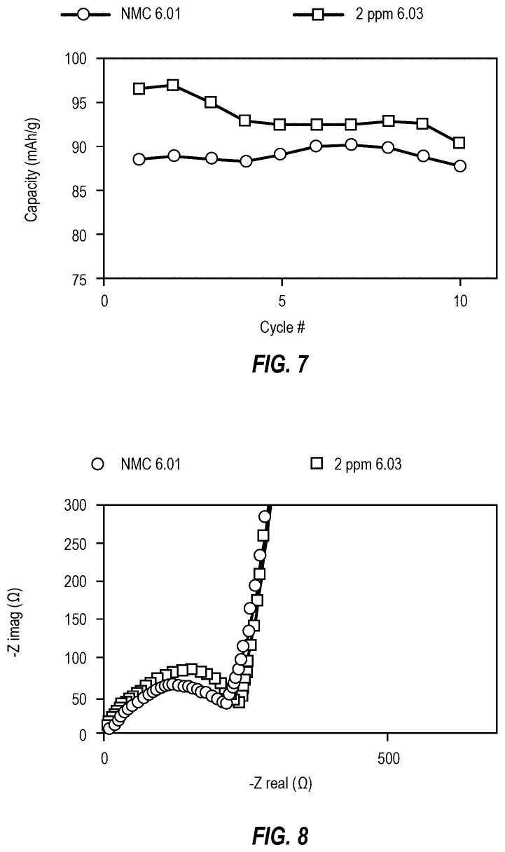

A comparative test was performed to compare the capacity, discharge rate, and charging rate of a conventional lithium-ion battery with the capacity, discharge rate, and charging rate, respectively, of the same type of battery modified to include spherical-shaped gold nanoparticles in the electrolyte and electrode paste. FIGS. 7-9 graphically represent the results of the test.

A plurality of 2023-type lithium-ion coin battery cells were manufactured and the electrode paste provided either with or without spherical-shaped gold nanoparticles. The gold nanoparticles had a particle size of 4 nm and a concentration of 2 ppm in the electrolyte and electrode paste. After 4-5 discharge and recharging cycles, the gold nanoparticles diffused from the electrode paste into the electrolyte and reached concentration equilibrium.

Electrochemical impedance spectroscopy (EIS) was performed using a Gamry 1010E Potentiostat. A 10-cycle run at 50 milliamps per gram with 2-4.2 Volts was performed, with the EIS device run at 0.11 mV intervals from 100 megahertz to 10 kilohertz to stress the batteries.

FIG. 7 is a graph that compares the discharge capacities of a standard 2023-type lithium-ion coin battery cell (ID: NMC 6.01) with an improved 2023-type lithium-ion coin battery cell containing gold nanoparticles in the electrolyte and electrode paste (ID: 2 ppm 6.03). The y-axis is the discharge capacity in units of mAh/g and the x-axis is the number discharge-recharge cycles. Throughout the test, which included 10 discharge-recharge cycles (CCD), the discharge capacity of the improved 2023-type lithium-ion coin battery cell containing gold nanoparticles in the electrolyte and electrode paste was greater than the discharge capacity of the standard 2023-type lithium-ion coin battery cell. The difference in discharge capacity was greater at the beginning (1-4 cycles) and then tapered off at 4-5 cycles. This was interpreted to show the diffusion from and equalization of the gold nanoparticles between the electrode paste and electrolyte.

FIG. 8 is a first Nyquist Plot comparing the impedances of a standard 2023-type lithium-ion coin battery cell (ID: NMC 6.01) with an improved 2023-type lithium-ion coin battery cell containing gold nanoparticles in the electrolyte and electrode paste (ID: 2 ppm 6.03). The first Nyquist Plot shows that the improved 2023-type lithium-ion coin battery cell containing gold nanoparticles in the electrolyte and electrode paste was able to discharge and recharge more rapidly than the standard 2023-type lithium-ion coin battery cell, particularly after going through 4-5 discharge-recharge cycles (CCD). The reduced impedance in the improved 2023-type lithium-ion coin battery cell was shown by the reduction of charge transfer resistance compared to the standard 2023-type lithium-ion coin battery cell.

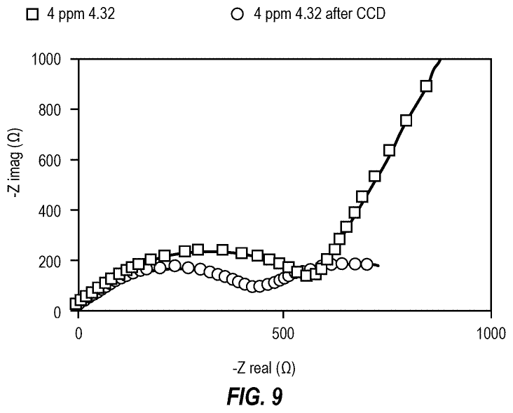

FIG. 9 is a second Nyquist Plot comparing the impedance of an improved 2023-type lithium-ion coin battery cell containing 4 ppm gold nanoparticles in the electrolyte and electrode paste (ID: 4 ppm 4.32) before and after 4-5 discharge-recharge cycles CCD. The second Nyquist Plot shows that the improved 2023-type lithium-ion coin battery cell was able to discharge and recharge more rapidly after going through 4-5 discharge-recharge cycles (“after CCD”). This indicates that the battery actually becomes more stable over time after CCD compared to the younger battery before CCD.

The comparative test yielded the following conclusions:
1. lithium-ion batteries that included the gold nanoparticles in the electrolyte and electrode paste had higher discharge capacity than lithium-ion batteries without the gold nanoparticles.
2. the rate of discharge and recharge was greater in lithium-ion batteries that included gold nanoparticles in the electrolyte and electrode paste compared to standard lithium-ion batteries, particularly after CCD.
3. the rate of discharge and recharge increased after CCD for the improved battery, which is different than standard lithium-ion batteries, which typically deteriorate after CCD.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An electrolyte for use in lithium-ion batteries comprising:
a carrier that is a liquid, gel, or solid;
one or more complexes of lithium ions selected from lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃); and
ground state metal nanoparticles formed by laser ablation.

2. The electrolyte of claim 1, wherein the carrier includes one or more organic carbonates selected from ethylene carbonate and diethyl carbonate.

3. The electrolyte of claim 1, wherein carrier comprises a polymer.

4. The electrolyte of claim 1, wherein the ground state metal nanoparticles comprise spherical-shaped gold nanoparticles.

5. The electrolyte of claim 4, wherein the spherical-shaped nanoparticles a diameter of less than about 20 nm, or less than about 15 nm, less than about 10 nm, or less than about 7 nm,

6. The electrolyte of claim 1, wherein the ground state metal nanoparticles are included in a concentration of at least 100 ppb and up to 100 ppm, or up to 50 ppm, or up to 25 ppm, or up to 10 ppm, or up to 5 ppm by weight of the electrolyte.

7. An electrode paste for use in lithium-ion batteries comprising:
a carrier comprising a binder;
one or more electrode active materials selected from negative electrode active materials and positive electrode active materials; and
ground state metal nanoparticles formed by laser ablation.

8. The electrode paste of claim 7, wherein the one or more electrode active materials comprise one or more positive electrode active materials selected from LiCoO₂, LiMnO₂, LiMn₂O₄, Li₂MnO₃, LiNiO₂, LiFePO₄, LiNiMnCoO₂, Li₄Ti₅O₁₂ and mixtures thereof.

9. The electrode paste of claim 7, wherein the one or more electrode active materials comprise one or more negative electrode active materials selected from mesophase carbon micro beads (MCMB), natural graphite powder, Li₄Ti₅O₁₂ and mixtures thereof.

10. The electrode paste of claim 7, wherein the ground state metal nanoparticles comprise spherical-shaped gold nanoparticles.

11. A lithium-ion battery having enhanced performance, comprising:
at least one negative electrode comprising ground state lithium (Li);
at least one positive electrode comprising a metal oxide that includes and/or is capable of forming a lithium-metal oxide; and
an electrolyte and/or electrode paste in contact with and/or positioned between the at least one negative electrode and the at least one positive electrode; and
a container in which the at least one negative electrode, the at least one positive electrode, and the electrolyte and/or electrode paste are positioned,
wherein:
the electrolyte comprises (i) a carrier that is a liquid, gel, or solid; (ii) one or more complexes of lithium ions selected from lithium hexafluorophosphate (LiPF₆), lithium hexafluoroarsenate monohydrate (LiAsF₆), lithium perchlorate (LiClO₄), lithium tetrafluoroborate (LiBF₄), and lithium triflate (LiCF₃SO₃); and (iii) ground state metal nanoparticles formed by laser ablation; and/or
the electrode paste comprising (i) a binder; (ii) one or more electrode active materials selected from negative electrode active materials and positive electrode active materials; (iii) and ground state metal nanoparticles formed by laser ablation.

12. The lithium-ion battery of claim 11, wherein the at least one negative electrode comprises lithium metal intercalated between layers of graphite.

13. The lithium-ion battery of claim 11, wherein the at least one positive electrode comprises at least one lithium-metal oxide selected from the group consisting of LiCoO₂, LiMnO₂, LiMn₂O₄, Li₂MnO₃, LiNiO₂, LiFePO₄, LiNiMnCoO₂, Li₄Ti₅O₁₂ and combinations thereof.

14. The lithium-ion battery of claim 13, wherein the at least one positive electrode comprises the lithium-metal oxide in intercalated between layers of metal oxide.

15. The lithium-ion battery of claim 11, wherein the ground state metal nanoparticles comprise spherical-shaped gold nanoparticles.

16. The lithium-ion battery of claim 11, wherein the electrolyte and/or electrode paste includes ground state metal nanoparticles in a concentration of at least 100 ppb and up to 100 ppm, or up to 50 ppm, or up to 25 ppm, or up to 10 ppm, or up to 5 ppm.

17. A method of manufacturing a lithium-ion battery of enhanced performance according to claim 11, comprising:
providing the electrolyte and/or electrode paste;
placing the electrolyte and/or electrode paste in contact with the at least one negative electrode comprising ground state lithium (Li);
placing the electrolyte and/or electrode paste in contact with the at least one positive electrode comprising a metal oxide that includes and/or is capable of forming a lithium-metal oxide; and
positioning the negative and positive electrodes and the electrolyte and/or electrode paste within the electrically insulating container.

18. The method of claim 17, wherein the at least one negative electrode comprises lithium metal intercalated between layers of graphite.

19. The method of claim 17, wherein the at least one positive electrode comprises at least one lithium-metal oxide selected from the group consisting of LiCoO₂, LiMnO₂, LiMn₂O₄, Li₂MnO₃, LiNiO₂, LiFePO₄, LiNiMnCoO₂, Li₄Ti₅O₁₂ and combinations thereof.

20. The method of claim 17, wherein the inclusion of the metal nanoparticles in the electrolyte and/or electrode paste increases at least one of battery lifespan, energy density, charge density per unit size or weight, safety, rate of discharge and production of current, rate of recharge, stability, longevity, and safety as compared to a same battery that omits the metal nanoparticles.
